(19) United States
(12) Patent Application Publication
(10) Pub. No.: US 2017/0280168 A1
(43) Pub. Date: Sep. 28, 2017

(54) Enhanced Viewing System

(71) Applicant: Brad Call, Freedom, WY (US)

(72) Inventor: Brad Call, Freedom, WY (US)

(21) Appl. No.: 15/081,649

(22) Filed: Mar. 25, 2016

(51) Int. Cl. H04N 21/218; H04N 21/4223; H04N 21/472; H04N 21/422; H04N 21/414; H04N 21/2187

(52) U.S. Cl. CPC H04N 21/21805; H04N 21/41407; H04N 21/2187; H04N 21/47202; H04N 21/42224; H04N 21/4223

(57) ABSTRACT

An enhanced viewing system is presented having a monitor on a pad connected wirelessly to a server whereon is presented several views of a sporting event. Cameras are typically placed on helmets of several players, and the viewer may select from among those views to enhance the event experience.

### BACKGROUND OF THE INVENTION

The enjoyment of viewing a sporting event live and in-person is often augmented by a large screen placed so that a segment of the viewing audience can see replays or several replays taken from different viewing angles. The ability to see a play from different angles may offset any disadvantage from your seat location.

### BRIEF SUMMARY OF THE INVENTION

Some embodiments of the invention utilize a portable viewing screen such as a tablet, smartphone or laptop from which different camera selections may be made. Live feeds from cameras imbedded into helmets provide a view as seen from the viewpoint of the wearer. Viewers may switch views, combine them so that more than one is present on the screen or in some embodiments, let someone else choose the views. Views may be switched quickly by utilizing a touchscreen to select from among several thumbnails, or depictions of the player. On non-touchscreen tablets, the views may be changed by keystrokes dedicated to each player. Depending on which helmeted sport one is viewing, American football for example, one may begin with the view of the quarterback and then switch to the receiver on a pass play. This may be done while watching the game in person or remotely. The most benefit will be achieved when watching the game in person and using the device to augment the viewing experience. In some embodiments, a time delay may be selected so that the play may be watched live, and then replayed during periods of inactivity or less activity. In some environments, not all players may need a camera, or the viewer may choose to leave the view on only one player. The feed may be recorded for training or other purposes or may be mixed to record a unique representation of the game. In non-helmet environments, headbands could be used to house the camera such as in soccer.

### BRIEF DESCRIPTION OF THE DRAWINGS

FIG. 1 depicts a helmet having a camera imbedded into the exterior shell;

FIG. 2 depicts a viewing screen having selection options from which to choose; and

FIG. 3 depicts a viewing screen having an alternate selection scheme.

### DETAILED DESCRIPTION OF THE INVENTION

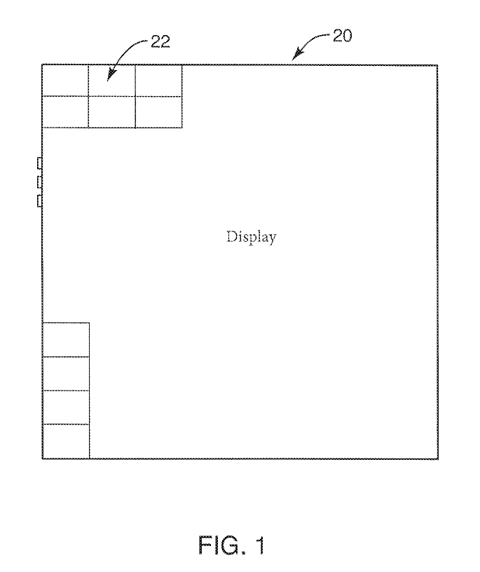

Referring first to FIG. 1, a display 20 is shown having several thumbnails 22 located along an edge of display 20 or stacked in a corner. As used in this application, the term viewer also may include audio capability. Each of thumbnails 22 represents a player wearing a camera/microphone in a sporting event, or an individual in some other group event. In some embodiments such as a race around a circuit, the thumbnails could also represent fixed cameras at various viewing points along the circuit. When selected by touching the thumbnail on a touchscreen or through keystrokes or buttons along the edge of the screen, the view represented by the thumbnail fills the screen and becomes the primary view. In some embodiments, once a view is selected, the thumbnails disappear until called up again by a keystroke, touching the screen or some other selection schema. One thumbnail may also be selected as the default view which is reverted to after a certain time period or when no activity has occurred for a period of time or when a separate button is pushed or a portion of the screen touched. A viewer may also customize the sequence and location of the thumbnails for more logic placement for the event being watched. For example, in American football, the quarterback may be the default view and sound, with receivers being placed next and running backs along another side. A viewer could then select the quarterback, see a pass play and select the receiver to view what the receiver is seeing as the pass is made.

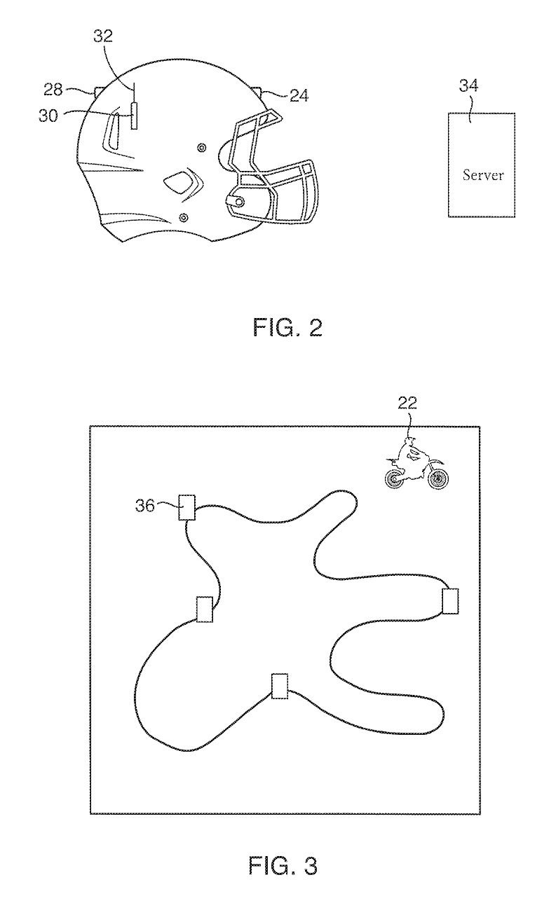

Referring now to FIG. 2, a camera 24 may be placed in a helmet 26 in helmeted sports, or in a headband or other clothing in non-helmeted sports. It is preferable to have the camera placed so as to give as close as possible the view seen by the player. In some sports, it may be beneficial to also have a second rear-viewing camera 28 placed in helmet 26 or clothing. A separate icon could be used to indicate that the viewer was selecting the rear-view from that player or location. The camera should be small and not project unduly from the helmet so as not to pose a safety hazard and to protect the lens of the camera from destructive contact. A transceiver 30 or transmitter is also located on the player in the helmet or some other location as well as an antenna 32. The view of the player is transmitted to a server 34 and then transmitted to a device containing display 20. The device also transmits to server 34 instructions as to which channel or view is selected.

FIG. 3 depicts an alternative screen arrangement for use in circuit events. The track or circuit is depicted on the screen with indicators 36 marking camera locations for selection by the viewer. Also available are a depiction of a participant such as a motorcycle rider with an icon/thumbnail 22 for the view of the rider and one looking back from the rear of the motorcycle. A viewer could then select from location views, rider view and motorcycle rear view.

What is claimed is:

1. An enhanced viewing system comprising:
a server capable of receiving a group of contemporaneous video and audio feeds originating from players in a sporting event to show the differing view of each player and transmitting at least a selected one of said group of video and audio feeds to a mobile device;
the mobile device having a display and a transceiver for receiving from the server one or more video and audio feeds; wherein the display has buttons or touchscreen icons to select one or more video views from among the group of video views so that the viewer may experience the sporting event from the vantage of selected different players.
